(19) United States
(12) Patent Application Publication
(10) Pub. No.: US 2019/0252970 A1
(43) Pub. Date: Aug. 15, 2019

(54) POWER CONVERSION APPARATUS AND LOGIC CIRCUIT

(71) Applicant: MITSUBISHI ELECTRIC CORPORATION, Tokyo (JP)

(72) Inventors: Satoshi OHDAIRA, Tokyo (JP); Koji UCHIMURA, Tokyo (JP)

(73) Assignee: Mitsubishi Electric Corporation, Tokyo (JP)

(21) Appl. No.: 16/316,553

(22) PCT Filed: Mar. 9, 2017
(86) PCT No.: PCT/JP2017/009604

§ 371 Date: Jan. 9, 2019

(51) Int. Cl. H02M 1/32; H02M 7/5387; H02P 27/08

(52) U.S. Cl. CPC H02M 1/32; H02M 2001/0009; H02P 27/08; H02M 7/53871

(57) ABSTRACT

A motor drive apparatus as a power conversion apparatus includes: a power conversion circuit that converts DC power to AC power and supplies resultant power to a motor; a control circuit that controls a plurality of switching elements that configures the power conversion circuit; a direct-current detection circuit that detects a direct current flowing into and out from the power conversion circuit; and an disconnection detection unit, configured by using a logic circuit, that detects an abnormality of one of the switching elements or a disconnection of one of power lines connecting the power conversion circuit to the motor on the basis of control signals output by the control circuit to the switching elements and a detection result obtained by the direct-current detection circuit.

### FIELD

The present invention relates to a power conversion apparatus that has a function of sensing a disconnection of a power line.

### BACKGROUND

A technique for sensing a disconnection of a power line is disclosed in Patent Literature 1, in which a disconnection of a load or an abnormality of a switching element in a power conversion circuit is determined by using a direct-current value, detected by a current detection unit placed on a DC side of a power conversion circuit, in a time period when a current of a voltage maximum phase or a voltage minimum phase flows. Another technique is disclosed in Patent Literature 2 in which a disconnection is determined by using the absolute value of a phase current sensed by a current sensor placed outside a power conversion circuit, a command torque, and the absolute value of a varying speed of the phase current.

### CITATION LIST

### Patent Literature

Patent Literature 1: Japanese Patent Application Laid-open No. 2010-11636

Patent Literature 2: Japanese Patent Application Laid-open No. 2014-85286

### SUMMARY

### Technical Problem

The invention described in Patent Literature 1 requires detection of a current value in a time period when current of the voltage maximum phase or voltage minimum phase flows, and needs an advanced arithmetic processing unit that can create a voltage command, such as a microcomputer (hereinafter referred to as microcomputer), as illustrated in FIG. 1 of Patent Literature 1. This technique thus poses a problem in that an operation cannot be performed in time if a switching cycle is short, that is, a problem in that applicable carrier cycles are limited. Furthermore, placing the arithmetic processing unit, such as a microcomputer, and the switching elements into one package requires heat and noise measures, thereby causing increase in size and cost of the package.

The invention described in Patent Literature 2 requires the placement of the current sensor outside the power conversion circuit for the determination of a disconnection, thereby causing increase in size and cost of the circuit. This technique also requires an arithmetic processing unit, such as a microcomputer, because its operation is based on a command torque, thus presenting problems similar to those of the invention described in Patent Literature 1.

As described above, the inventions described in Patent Literatures 1 and 2 require analysis by an arithmetic processing unit, such as a microcomputer, and a sensor outside a power conversion circuit for determining a disconnection, thus causing increase in size and cost of the package. Furthermore, applicable carrier frequencies are limited.

The present invention has been achieved in view of the above, and an object of the present invention is to provide a power conversion apparatus that can achieve reduction in size of the apparatus and enhancement in performance of disconnection sensing.

### Solution to Problem

To solve the problems described above and achieve the object described above, a power conversion apparatus according to the present invention includes: a power conversion circuit that converts DC power to AC power and supplies resultant power to a load; a control circuit that controls a plurality of switching elements that configures the power conversion circuit; and a direct-current detection circuit that detects a direct current flowing into and out from the power conversion circuit. The power conversion apparatus also includes an abnormality detection unit, configured by using a logic circuit, that detects an abnormality of one of the switching elements or a disconnection of one of power lines connecting the power conversion circuit to the load on the basis of control signals output by the control circuit to the switching elements and a detection result obtained by the direct-current detection circuit.

### Advantageous Effects of Invention

A power conversion apparatus according to the present invention produces an effect of enabling reduction in size of the apparatus and enhancement in performance of disconnection sensing.

### BRIEF DESCRIPTION OF DRAWINGS

FIG. 1 is a diagram illustrating an exemplary configuration of a power conversion apparatus according to a first embodiment.

FIG. 2 is a diagram illustrating an exemplary configuration of a voltage-command creation unit according to the first embodiment.

FIG. 3 is a diagram for describing an operation of a direct-current detection circuit according to the first embodiment.

FIG. 4 is a diagram illustrating an exemplary configuration of a disconnection detection unit according to the first embodiment.

FIG. 5 is a diagram illustrating examples of a voltage command values, a carrier wave, and PWM signals for use in control of an inverter circuit in a motor drive apparatus according to the first embodiment.

FIG. 6 is a diagram illustrating all possible switching patterns that may be present when the inverter circuit is controlled by using the PWM signals illustrated in FIG. 5.

FIG. 7 is a diagram illustrating another examples of the voltage command values, the carrier wave, and the PWM signals for use in control of the inverter circuit in the motor drive apparatus according to the first embodiment.

FIG. 8 is a diagram illustrating another exemplary configuration of the disconnection detection unit according to the first embodiment.

FIG. 9 is a diagram illustrating an exemplary configuration of a power conversion apparatus according to a second embodiment.

FIG. 10 is a diagram illustrating a correspondence relationship between failure locations and switching patterns in the power conversion apparatus according to the second embodiment.

FIG. 11 is a diagram illustrating an example abnormality-location identification signal output by an abnormality notification unit of the power conversion apparatus according to the second embodiment.

FIG. 12 is a diagram illustrating an exemplary configuration of a power conversion apparatus according to a third embodiment.

FIG. 13 is a diagram illustrating a first example of an abnormality detection method performed by a current-detection-circuit abnormality diagnosis unit of the power conversion apparatus according to the third embodiment.

FIG. 14 is a diagram illustrating a second example of the abnormality detection method performed by the current-detection-circuit abnormality diagnosis unit of the power conversion apparatus according to the third embodiment.

FIG. 15 is a diagram illustrating an exemplary configuration of a power conversion apparatus according to a fourth embodiment.

### DESCRIPTION OF EMBODIMENTS

Exemplary embodiments of a power conversion apparatus according to the present invention are described below in detail with reference to the drawings. The present invention is not limited to the embodiments.

### First Embodiment

FIG. 1 is a diagram illustrating an exemplary configuration of a power conversion apparatus according to a first embodiment of the present invention. FIG. 1 illustrates a case in which the power conversion apparatus according to the present embodiment is a motor drive apparatus 111 as an example, and the motor drive apparatus 111 is connected to a motor 4 that is a load.

As illustrated in FIG. 1, the motor drive apparatus 111 according to the present embodiment includes an inverter circuit 3 that is power conversion circuit that includes a plurality of switching elements 9, a shunt resistor 5 that is connected to an N side of the inverter circuit 3, a voltage-command creation unit 1, a PWM pulse generation unit 13, and a direct-current detection circuit 106. The motor drive apparatus 111 also includes shunt resistors 105 that are each connected to a corresponding one of power lines 127 of a U phase, a V phase, and a W phase, a motor-current detection circuit 107, a motor-current detection unit 118, a disconnection detection unit 108, an abnormality notification unit 119, an alarm processing unit 120, and a drive circuit 2. Examples of the switching element 9 include an insulated gate bipolar transistor (IGBT). In FIG. 1, one of the switching elements on a P side, that is, an upper arm side, of the U phase is denoted as “U+”, and one of the switching elements on the N side, that is, a lower arm side, of the U phase is denoted as “U−”. Those of the switching elements of the V phase and W phase are also denoted similarly,

The motor-current detection unit 118, the voltage-command creation unit 1, the PWM pulse generation unit 13, and the alarm processing unit 120 can be accommodated in a single control circuit 110 by using a semiconductor integrated circuit, such as a microcomputer or a digital signal processor (DSP). The shunt resistors 105 can be connected to the power lines 127 for any two of the three phases (the U phase and the V phase, the U phase and the W phase, or the V phase and the W phase). The direct-current detection circuit 106, the disconnection detection unit 108, the abnormality notification unit 119, and the drive circuit 2 can be accommodated in one package as a multi-function drive circuit 113. The inverter circuit 3, which includes the switching elements 9, the shunt resistor 5, which is connected to the N side of the inverter circuit 3, the direct-current detection circuit 106, the disconnection detection unit 108, the abnormality notification unit 119, and the drive circuit 2 can be accommodated in one package as an intelligent power module (IPM) 112.

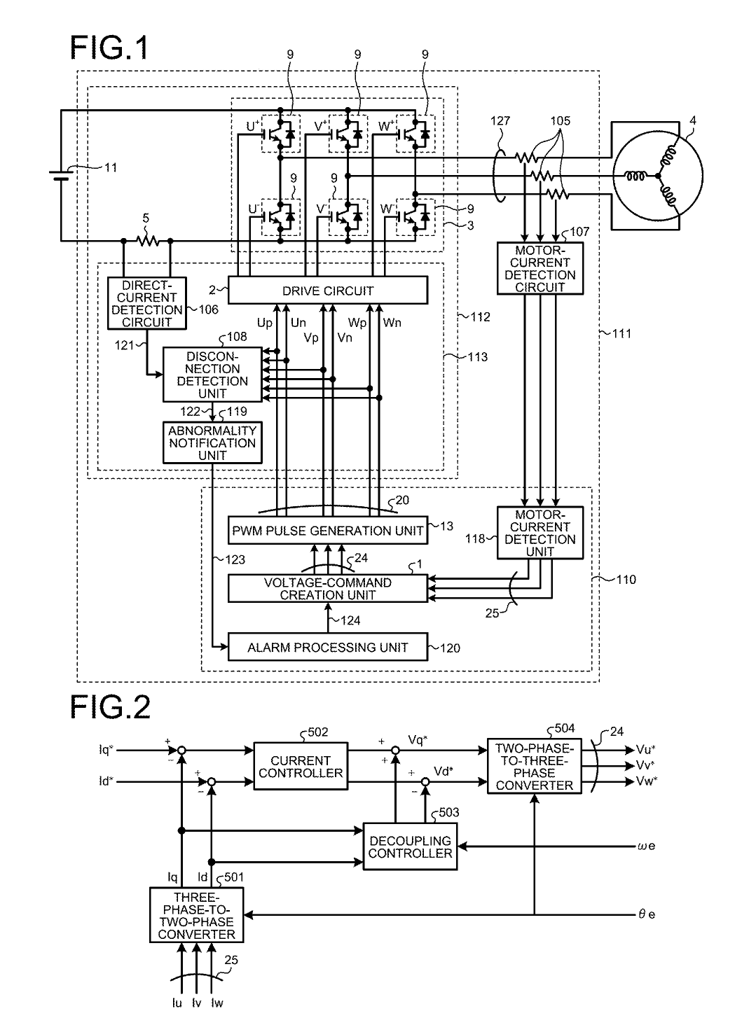

The voltage-command creation unit 1 creates three-phase voltage command values 24 on the basis of motor-current detection values 25 detected by the motor-current detection unit 118 and a motor constant. The motor 4 is, for example, a permanent-magnet motor that includes a rotor configured by using a permanent magnet and a plurality of windings placed around the rotor for forming an alternating field. A permanent-magnet motor can be driven by generating a voltage command by using current control based on a generally well-known dq coordinate system and driving the permanent-magnet motor in accordance with the voltage command. In this case, the voltage-command creation unit 1 includes, for example, a three-phase-to-two-phase converter 501, a current controller 502, a decoupling controller 503, and a two-phase-to-three-phase converter 504 as illustrated in FIG. 2. The three-phase-to-two-phase converter 501 performs dq transformation using an electrical angle θe to achieve coordinate transformation from the motor-current detection values (Iu, Iv, Iw) 25 on three-phase AC axes to currents (Id, Iq) on a d-axis and a q-axis. The current controller 502 converts a value obtained by subtracting the current value Id from a current command value Id* on the d-axis (Id*−Id) and a value obtained by subtracting the current value Iq from a current command value Iq* on the q-axis (Iq*−Ig) to voltage values and outputs results. The decoupling controller 503 generates a voltage for each of the d-axis and the q-axis for cancelling speed electromotive forces that interfere with each other between the d-axis and the q-axis on the basis of the current value Id of the d-axis, the current value Iq of the q-axis, and an electrical angular velocity Adding the voltage value of the q-axis output by the current controller 502 and the voltage value of the q-axis output by the decoupling controller 503 together results in a voltage command value Vq* of the q-axis; subtracting the voltage value of the d-axis output by the decoupling controller 503 from the voltage value of d-axis output by the current controller 502 results in a voltage command value Vd* of the d-axis. The two-phase-to-three-phase converter 504 performs coordinate transformation from the dq axes to the three-phase AC axes using the electrical angle θe so as to convert the voltage command values (Vq*, Vd*) of the dq axes to voltage command values (Vu*, Vv*, and Vw*) 24 of the three-phase AC axes. Here, the d-axis is defined as a position of a rotor magnet in a magnetic flux direction, and the q-axis is defined as a position obtained by further advancing in a rotation direction by 90 degrees in an electrical angle.

A value detected by a position sensor, such as an encoder, that is attached on the rotor may be used as the electrical angle θe for use in the processing performed by the three-phase-to-two-phase converter 501 and the two-phase-to-three-phase converter 504; alternatively, a value obtained by estimating a rotor position from information such as a voltage command value or a current detection value may be used. The electrical angular velocity ωe used by the decoupling controller 503 may be obtained by an operation using the electrical angle θe.

With reference back to FIG. 1, the PWM pulse generation unit 13 compares the three-phase voltage command values 24 to a triangular wave that is a pulse width modulation (PWM) carrier signal, and generates PWM signals 20 (Up, Un, Vp, Vn, Wp, and Wn) for controlling the switching elements 9. Here, Up is a control signal for controlling the switching element 9 of the U phase on the P side; Un is a control signal for controlling the switching element 9 of the U phase on the N side. Vp is a control signal for controlling the switching element 9 of the V phase on the P side; Vn is a control signal for controlling the switching element 9 of the V phase on the N side. Wp is a control signal for controlling the switching element 9 of the W phase on the P side; Wn is a control signal for controlling the switching element 9 of the W phase on the N side.

The drive circuit 2 generates drive signals for driving the switching elements 9 on the basis of the PWM signals 20. A DC voltage from a DC voltage source 11 is applied to the inverter circuit 3, and the inverter circuit 3 turns on/off the switching elements 9 in accordance with the drive signals input by the drive circuit 2 to thereby generate a three-phase AC voltage that is applied to the motor 4.

The motor-current detection circuit 107 is a circuit for detecting a current accurately from an analog voltage value across each of the shunt resistors 105, which is placed on a corresponding one of the power lines 127 in the U, V, and W phases, which connect the inverter circuit 3 to the motor 4. The motor-current detection circuit 107 performs, for example, Σ−Δ conversion on the analog voltage value across each of the shunt resistors 105 to thereby generate a bit stream that is subjected to filtering processing performed by the motor-current detection unit 118 using a filter such as an infinite impulse response (IIR) filter to obtain a digital value of the voltage. Then, the voltage value is divided by a resistance value of each of the shunt resistors 105 to thereby obtain a digital current value for each of the U, V, and W phases. Note that there is no need to place the shunt resistors 105 for ail of the three phases, U, V, and W; a shunt resistor 105 can be placed for any two of the phases and a digital current value for the remaining one phase can be calculated from a balanced condition (Iu+Iv+Iw=0).

The shunt resistor 5 connected to a DC side of the inverter circuit 3. Generally, the shunt resistor 5 is connected to detect a state in which an overcurrent flows through the inverter circuit 3 and thereby protect the switching elements 9. In the present embodiment, the shunt resistor 5 is used not only for protecting the switching elements 9 but also for detecting a disconnection of one of the power lines 127, which are connected to the motor 4, or an abnormality of the inverter circuit 3. A method in which disconnection detection is performed by using the shunt resistor 5, which is originally needed for protecting the switching elements 9, is very effective at reducing the number of components and the area of a board.

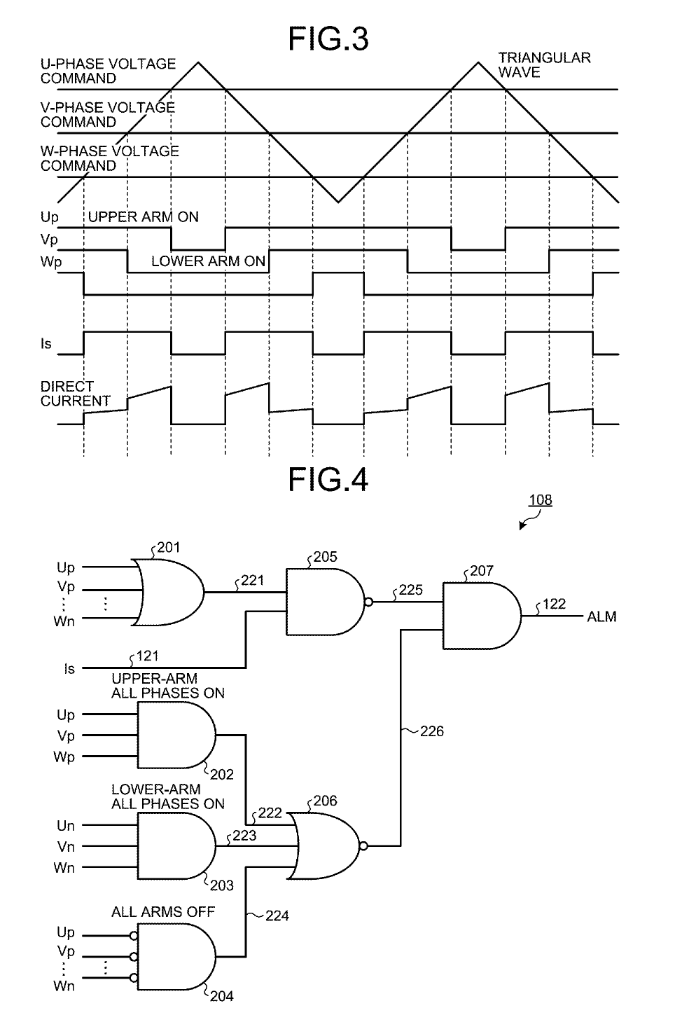

The direct-current detection circuit 106 generates a direct-current detection signal 121 (Is) from a voltage across the shunt resistor 5 and outputs a result to the disconnection detection unit 108. As illustrated in FIG. 3, the direct-current detection signal 121 (Is) is a signal that becomes active, or achieves a high level, when a direct current flows through the inverter circuit 3. Actually, this signal becomes active when a direct current having a value equal to or greater than a threshold value flows for a certain time period or longer, due to effects of switching noise of the switching elements 9 and freewheeling diode current in the switching elements 9. In other words, the direct-current detection circuit 106 detects a state in which a direct current flows into and out from the inverter circuit 3 and outputs the direct-current detection signal 121 (Is), which indicates a detection result.

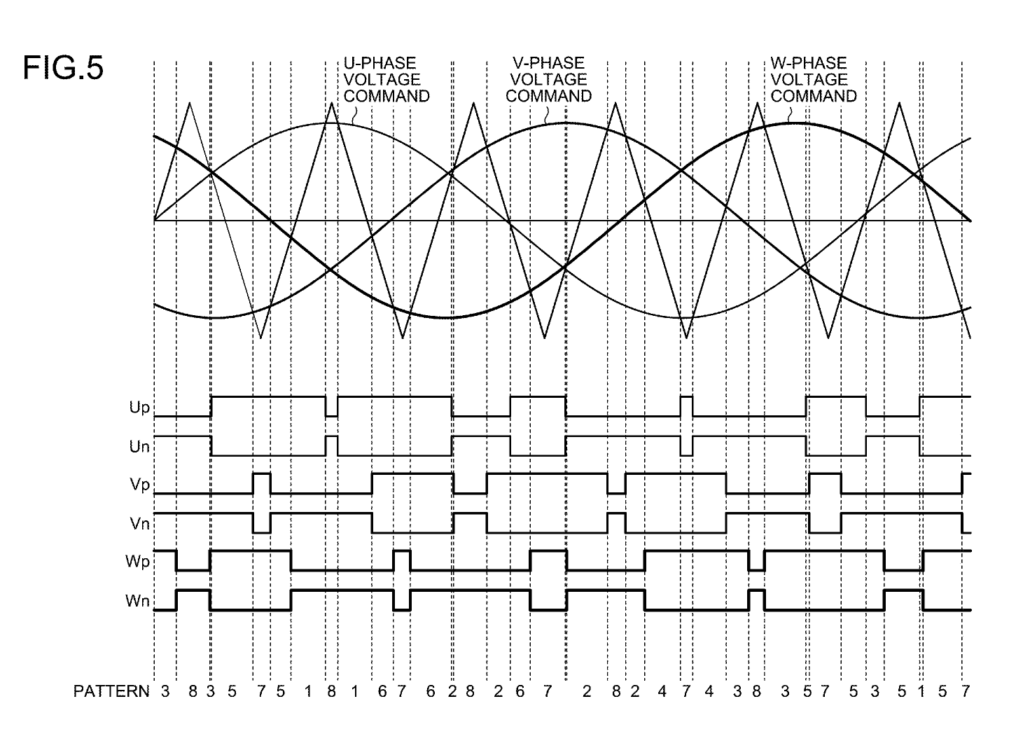

The disconnection detection unit 108 detects an abnormality of one of the switching elements 9 and a disconnection of one of the power lines 127 by using the direct-current detection signal 121 (Is), which is generated by the direct-current detection circuit 106, and the PWM signals 20 (Up, Un, Vp, Vn, Wp, and Wn), which are generated by the PWM pulse generation unit 13. The disconnection detection unit. 108 is an abnormality detection unit. The disconnection detection unit 108 can be made by using a logic circuit as illustrated, for example, in FIG. 4. The logic circuit illustrated in FIG. 4 includes an OR circuit 201, AND circuits 202 to 204 and 207, a NAND circuit 205, and a NOR circuit 206. The OR circuit 201 receives the PWM signals 20 (Up, Un, Vp, Vn, Wp, and Wn); the AND circuit 202 receives control signals that correspond to the switching elements 9 on the P side, among the PWM signals 20 (Up, Vp, and Wp); the AND circuit 203 receives control signals that correspond to the switching elements 9 on the N side, among the PWM signals 20 (Un, Vn, and Wn). The AND circuit 204 receives the PWM signals 20 (Up, Un, Vp, Vn, Wp, and Wn) that are inverted. The NAND circuit 205 receives an output signal 221 from the OR circuit 201 and the direct-current detection signal 121 (Is) from the direct-current detection circuit 106. The NOR circuit 206 receives an output signal 222 from the AND circuit 202, an output signal 223 from the AND circuit 203, and an output signal 224 from the AND circuit 204. The AND circuit 207 receives an output signal 225 from the NAND circuit 205 and an output signal 226 from the NOR circuit 206. The AND circuit 207 outputs a disconnection detection signal 122 (ALM) that is at the high level when an abnormality of one of the switching elements 9 or a disconnection of one of the power lines 127 occurs.

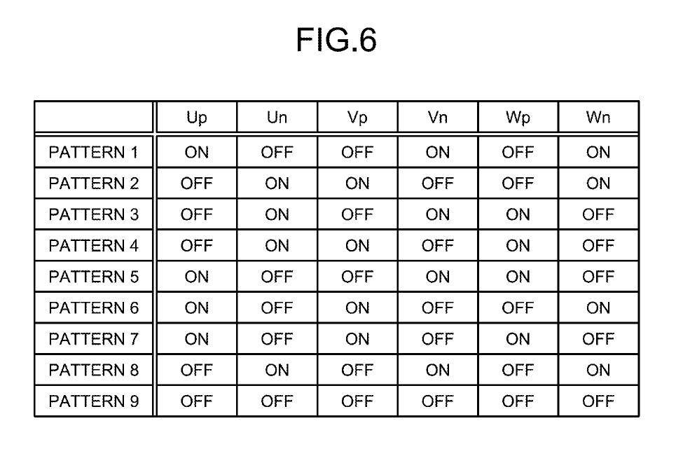

There are normally nine switching patterns illustrated in FIGS. 5 and 6 in total for driving the motor. An upper portion of FIG. 5 indicates the voltage command value for each of the U phase, the V phase, and the W phase and their relationships with the triangular wave, which is a carrier wave; a lower portion of FIG. 5 indicates the PWM signals that corresponds to the voltage command values and the carrier wave indicated in the upper portion. Numbers at the lower part of FIG. 5 correspond to numbers of patterns from a pattern 1 to a pattern 9 indicated in FIG. 6. Among the nine patterns indicated in FIG. 6, the patterns 7 to 9, that is, the pattern 7 in which the switching elements 9 on the P side are all on and the switching elements 9 on the N side are all off, the pattern 8 in which the switching elements 9 on the P side are all off and the switching elements 9 on the N side are all on, and the pattern 9 in which the switching elements 9 on the P and N sides are all off, pose a risk of erroneous detection of a disconnection due to a regenerative current that causes a direct current to flow through the N side of the inverter circuit 3. The AND circuits 202, 203, and 204 and the NOR circuit 206 in the logic circuit illustrated in FIG. 4 thus configure a circuit for masking the patterns 7 to 9 in FIG. 6, and this circuit generates the output signal 226, which is a disconnection-detection mask signal. The AND circuit 202 detects the pattern 7, the AND circuit 203 detects the pattern 8, and the AND circuit 204 detects the pattern 9. The disconnection-detection mask signal becomes inactive, or achieves a low level, if any of the patterns 7 to 9 is present. The AND circuit 207 carries out the logical AND between the output signal 225 from the NAND circuit 205 and the disconnection-detection mask signal to thereby mask the patterns 7 to 9, which pose a risk of erroneous detection. The logic circuit illustrated in FIG. 4 causes the disconnection detection signal 122 (ALM) to become the high level if the state of the switching elements 9 of the inverter circuit 3 corresponds to any of the patterns 1 to 6 indicated in FIG. 6 and the direct-current detection signal 121 (Is) achieves the low level, that is, no current flows through the inverter circuit 3. The disconnection detection unit 108 can be configured using the simple logic circuit illustrated in FIG. 4 and enables high-speed processing of the abnormality detection for the switching elements 9 and the disconnection detection for the power lines 127.

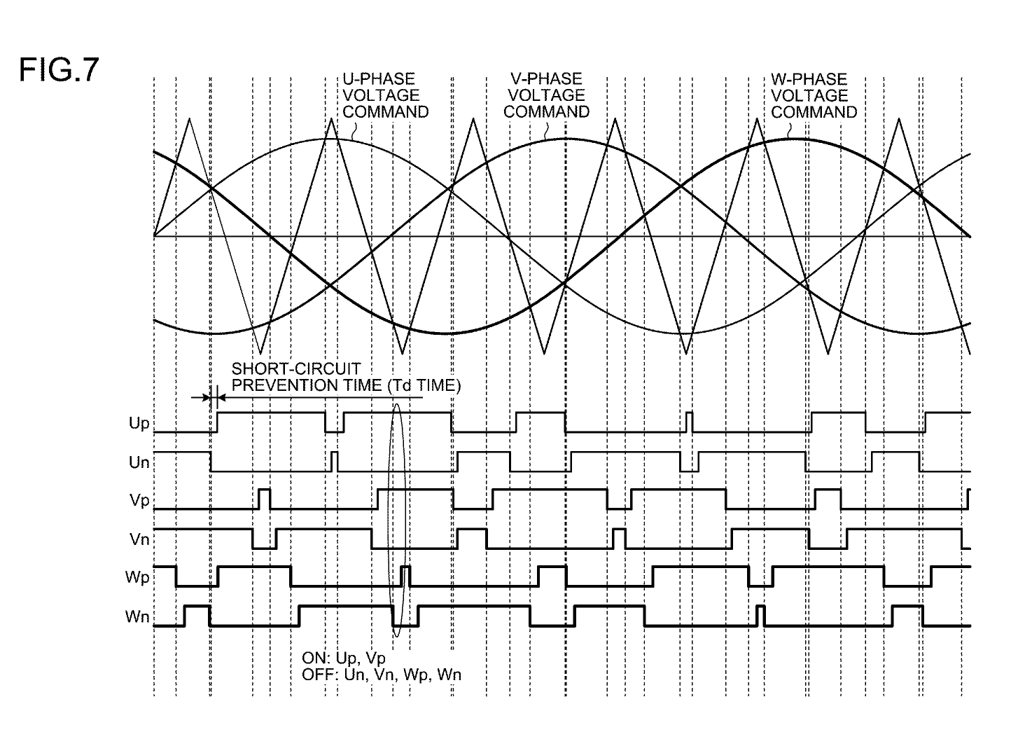

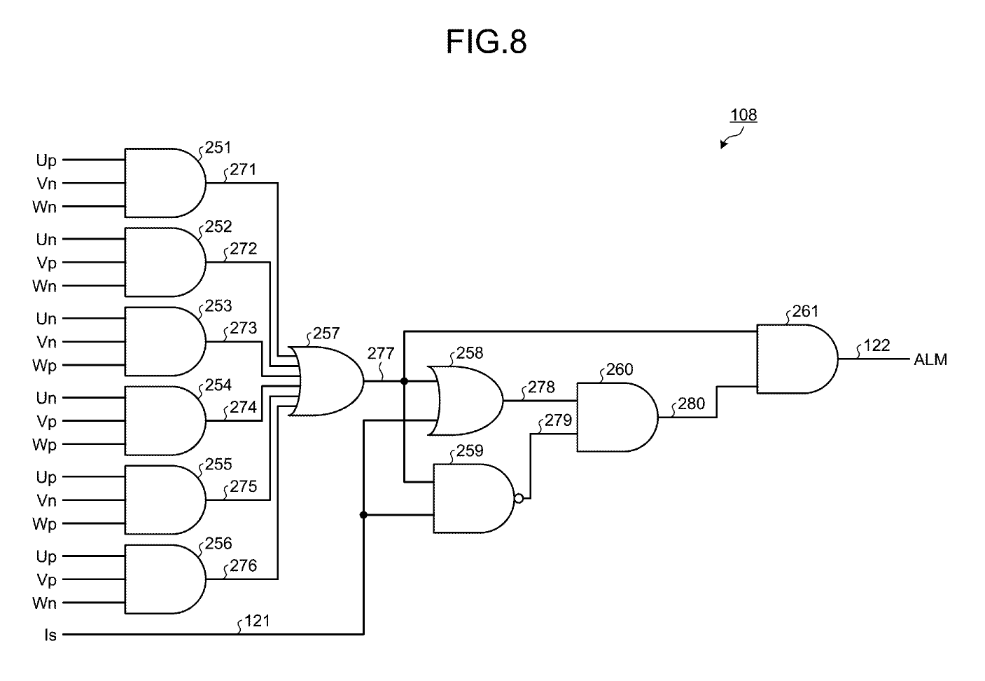

The timing at which one of the switching elements 9 of one of the phases is turned from off to on, is delayed from the timing at which the other one of the switching elements 9 of the same phase is turned from on to off in some cases to prevent a short circuit between the switching elements 9 of the upper and lower arms. Switching patterns other than the nine patterns indicated in FIG. 6 are conceivable in this case. For example, as illustrated in FIG. 7, when a state in which Up, Vp, and Wn are on (and the remaining Un, Vn, and Wp are off) transitions to a state in which Up, Vp, and Wp are on (and Un, Vn, and Wn are off), the time at which Wp is turned on is delayed for a time for preventing short-circuit (Td time). In this case, there is a segment in which Up and Vp are on (and the remainder is all off) for the delay time; the logic circuit illustrated in FIG. 4 may erroneously detect an abnormality in this segment due to the absence of the flow of direct current although the switching operation is performed. It is effective in such cases to use a logic circuit as illustrated in FIG. 8 so as to detect a disconnection in a limited segment that corresponds to the six patterns from the pattern 1 to the pattern 6 illustrated in FIG. 6. In the logic circuit illustrated in FIG. 8, an AND circuit 251 detects the state of the pattern 1 illustrated in FIG. 6; similarly, AND circuits 252 to 256 detect the states of the respective patterns 2 to 6. Output signals from the AND circuits 251 to 256 are input to an OR circuit 257, and an output signal 277 of the OR circuit 257, together with the direct-current detection signal 121 (Is), is input to an OR circuit 258 and a NAND circuit 259. The output signal 277 of the OR circuit 257 is input also to an AND circuit 261. An output signal 278 of the OR circuit 258 and an output signal 279 of the NAND circuit 259 are input to an NAND circuit 260. An output signal 280 of the NAND circuit 260 is input to the AND circuit 261, and the AND circuit 261 outputs the disconnection detection signal 122 (ALM) at a level based on the signals 277 and 280 that are input. The output signal of the OR circuit 257, which becomes the high level if a state of any of the patterns 1 to 6 is present, is input to the AND circuit 261, which is the final circuit; thus, the disconnection detection signal 122 (ALM) becomes the low level if a state other than those of the patterns 1 to 6 is present and can thereby prevent an erroneous detection.

When the disconnection detection signal 122 output by the disconnection detection unit 108 is at the high level, which indicates that a disconnection is detected, the abnormality notification unit 119 latches the signal and outputs it as a disconnection abnormality signal 123 that indicates that there is an abnormality such as a disconnection, thereby notifies the control circuit 110, which is realized by using a microcomputer or the like, of the abnormal state. To prevent a malfunction due to noise or the like, the abnormality notification unit 119 may be configured to output the disconnection abnormality signal 123 when the disconnection detection signal 122 becomes active, i.e., the high level, more than once. Here, to output the disconnection abnormality signal 123 means that the abnormality notification unit 119 outputs a signal at the high level. The power conversion apparatus according to the present embodiment serves the purpose of transmitting an abnormal state such as a disconnection immediately; thus, only the disconnection abnormality signal 123 is transmitted to the alarm processing unit 120 in the control circuit 110. To identify the location of the abnormality, the power conversion apparatus according to the present embodiment uses an off-line test pulse (individual switching) after the motor is stopped. A power conversion apparatus that has a function of identifying the location of an abnormality and a function of notifying the location is described in a second embodiment.

When receiving the disconnection abnormality signal 123, which is generated by the abnormality notification unit 119, the alarm processing unit 120 displays the disconnection state on a display (not illustrated) attached on the motor drive apparatus 111 to thereby notify the outside and also notifies another device via a network illustration of which is omitted. The alarm processing unit 120 also transmits a motor stop command 124 to the voltage-command creation unit 1. On reception of the motor stop command 124 from the alarm processing unit 120, the voltage-command creation unit 1 generates a voltage command to turn off (interrupt) all switches of the switching elements 9 to thereby stop the motor 4, if coasting of the motor is allowed. If minimization of the motor coasting distance is desired, in the motor drive apparatus 111, the voltage-command creation unit 1 stops the motor 4 by using a dynamic brake in which the power lines of the U, V, and W phases are short circuited via the resistors or using deceleration stop control, in addition to the voltage-command creation unit 1 generating the voltage command to turn off all the switches of the switching elements 9. In the case of a servo system, for example, the voltage-command creation unit 1 in the motor drive apparatus 111, which serves as a servo amplifier, performs the deceleration stop control on the basis of velocity information and position information from a position sensor connected to a servomotor that serves as a load and a deceleration command. Description of the deceleration stop control, which is not in the scope of the present invention, is omitted.

The operations described above to stop the motor 4 in response to the determination of an abnormality can be performed, without going through the control circuit 110, by transmitting the disconnection abnormality signal 123 to the drive circuit 2 in the multi-function drive circuit 113 or in the IPM 112 and causing the drive circuit 2 to turn off all the switches of the switching elements 9.

The motor drive apparatus 111 according to the present invention does not include a shunt resistor that integrates the shunt resistors 105 for motor current detection and the shunt resistor 5 for disconnection detection unlike the inventions disclosed in Patent Literatures 1 and 2, because of the difference in their purposes. While a disconnection needs to be detected as swift as possible from the viewpoint of the protection of the motor and mechanical portions connected to the motor, a motor current needs to be detected with high accuracy from the viewpoint of the control of the motor. The present invention thus achieves the disconnection detection by using a fast current-detection circuit that does not go so far as to perform A/D conversion on a current value, i.e., the direct-current detection circuit 106, whereas the present invention achieves the motor current detection by using the motor-current detection circuit 107, which performs the A/D conversion such as Σ-Δ to thereby detect the current with high accuracy.

The method of detecting a disconnection by using a hardware logic can be used in the case of high-speed carrier cycles, because the method does not require analysis by an advanced arithmetic processing unit, such as a microcomputer. This method is applicable to cases where switching cycles are short due to, for example, servomotor drive, induction motor drive, and other types of high-carrier-cycle drive. This method is also applicable when a motor is stopped in addition to when the motor is being driven. This method thus is a very effective disconnection detection method that can detect a disconnection and an abnormality of a switching element regardless of the carrier frequency and the driving condition and operational state of a motor and can detect a disconnection reliably also when the motor is being driven.

As described above, the motor drive apparatus 111, which is the power conversion apparatus according to the present embodiment, includes the disconnection detection unit 108, which detects a disconnection of one of the power lines 127 between the inverter circuit 3, which generates a three-phase AC voltage that is applied to the motor 4, and the motor 4 and an abnormality of one of the switching elements 9, which configure the inverter circuit 3, on the basis of a current that flows through the inverter circuit 3 and the PWM signals, which control the switching elements 9, which configure the inverter circuit 3; the disconnection detection unit 108 is configured using a logic circuit. Accordingly, the disconnection detection unit 108 can be integrated into one package in the IPM or a gate-actuating integrated circuit (IC), thus enabling reduction in size and cost of the power conversion apparatus. The motor drive apparatus ill can also detect an abnormality of a switching element and a disconnection of a power line when used in a system with a high-speed carrier cycle.

### Second Embodiment

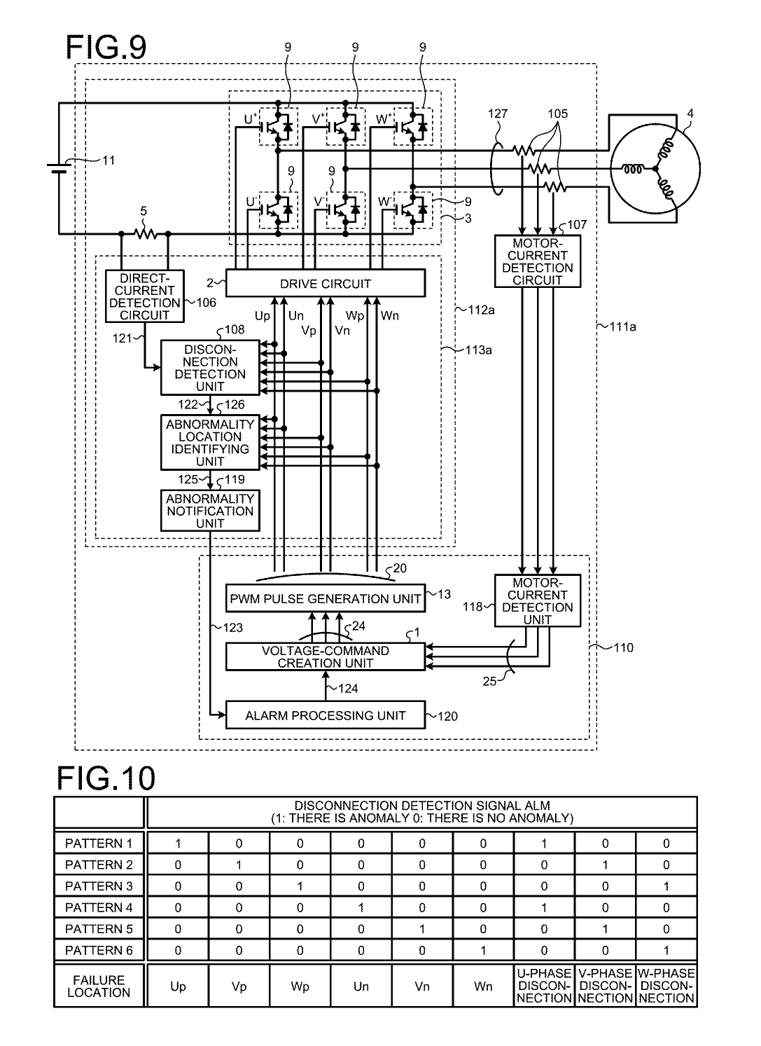

FIG. 9 is a diagram illustrating an exemplary configuration of a power conversion apparatus according to a second embodiment of the present invention. The power conversion apparatus illustrated in FIG. 9 is a motor drive apparatus as with the power conversion apparatus described in the first embodiment (see FIG. 1). In FIG. 9, constituent elements common with the motor drive apparatus 111 described in the first embodiment are designated with identical symbols. Description of the constituent elements common with the motor drive apparatus 111 described in the first embodiment is omitted in the present embodiment.

A motor drive apparatus 111a according to the second embodiment has a configuration that is similar to that of the motor drive apparatus 111 according to the first embodiment but further includes an abnormality-location identifying unit 126. As in the motor drive apparatus 111, the direct-current detection circuit 106, the disconnection detection unit 108, the abnormality notification unit 119, the abnormality-location identifying unit 126, and the drive circuit 2 can be accommodated in one package as a multi-function drive circuit 113a. The inverter circuit 3, the shunt resistor 5, the direct-current detection circuit 106, the disconnection detection unit 108, the abnormality-location identifying unit 126, the abnormality notification unit 119, and the drive circuit 2 can be also accommodated in one package as an IPM 112a.

The abnormality-location identifying unit 126 identifies an abnormality location, that is, identifies one of the switching elements that has an abnormality and one of the power lines that has a disconnection on the basis of the PWM signals 20, which are generated by the PWM pulse generation unit 13, and the disconnection detection signal 122, which is output by the disconnection detection unit 108, and generates an abnormality-location identification signal 125.

The abnormality-location identifying unit 126 identifies an abnormality location by using a correspondence table illustrated in FIG. 10. Specifically, the abnormality-location identifying unit 126 checks one of switching patterns 1 to 6 that is exhibited when the disconnection detection signal 122 (ALM) becomes active per one rotation by the electrical angle, against the correspondence table illustrated in FIG. 10 and thereby identifies the abnormality location. The patterns 1 to 6 are the patterns 1 to 6 indicated in FIG. 6. For example, it is only Up that is on on the P side in the pattern 1; thus, if the disconnection detection signal 122 becomes active only in a segment of the pattern 1 per one ration by the electrical angle, the abnormality-location identifying unit 126 determines that the Up switching element 9 is experiencing an open circuit or that the U phase is disconnected. In another example, if the disconnection detection signal 122 becomes active in two segments of the patterns 1 and 4 per one ration by the electrical angle, the Up and Un switching elements 9 are experiencing open circuits or the U phase including the motor winding is disconnected. Generally, failures are not likely to be caused in two locations simultaneously; thus, the abnormality-location identifying unit 126 determines that the U phase is disconnected in this case. The abnormality-location identifying unit 126 determines an abnormality location on the basis of a switching pattern exhibited when the disconnection detection signal 122 (ALM) becomes active in a manner described above. The abnormality-location identifying unit 126 can be realized by using a logic circuit as with the disconnection detection unit 103.

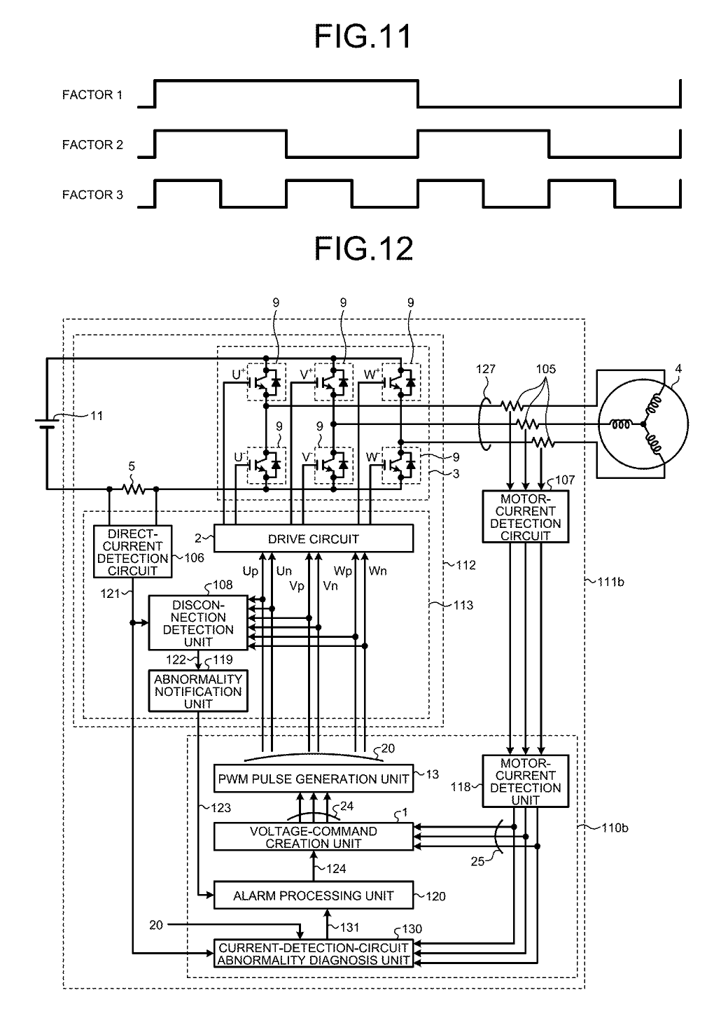

The abnormality notification unit 119 receives abnormality location information identified by the abnormality-location identifying unit 126 in the form of the abnormality-location identification signal 125 and notifies the alarm processing unit 120 in the control circuit 110 of the abnormality occurrence and the abnormality location by way of the disconnection abnormality signal 123. Any transmitting method can be used; for example, a pulse width may be modulated in accordance with an abnormality location (factor) and transmitted, as illustrated in FIG. 11. This enables transmission of multiple pieces of information using a one-pin signal. The notification from the abnormality-location identifying unit 126 to the abnormality notification unit 119 may be achieved by the same method. The alarm processing unit 120 detects the abnormality on the basis of a rising edge of the disconnection abnormality signal 123 and acquires the abnormality location information by counting the active time. Having received the abnormality location information from the abnormality notification unit 119, the alarm processing unit 120 performs operations similar to those described in the first embodiment to thereby notify the outside and another device of the abnormality location and performs processing to stop the motor 4.

As described above, the motor drive apparatus 111a according to the present embodiment detects an abnormality by using a circuit similar to that used in the motor drive apparatus 111 according to the first embodiment and, if an abnormality is detected, also identifies the abnormality location by using the abnormality-location identifying unit 126. The present embodiment can thus produce effects similar to those produced by the motor drive apparatus 111 according to the first embodiment. The present embodiment can also identify an abnormality occurrence location and notify a user of the location, thereby enables reduction in time taken for maintenance work performed when an abnormality occurs.

### Third Embodiment

FIG. 12 is a diagram illustrating an exemplary configuration of a power conversion apparatus according to a third embodiment of the present invention. The power conversion apparatus illustrated in FIG. 12 is a motor drive apparatus as with the power conversion apparatuses described in the first and second embodiments (see FIGS. 1 and 9). In FIG. 12, constituent elements common with the motor drive apparatus 111 described in the first embodiment are designated with identical symbols. Description of the constituent elements common with the motor drive apparatus 111 described in the first embodiment is omitted in the present embodiment.

A motor drive apparatus 111b according to the third embodiment has a configuration that is similar to that of the motor drive apparatus 111 according to the first embodiment but further includes a current-detection-circuit abnormality diagnosis unit 130. As in the motor drive apparatus 111, the motor-current detection unit 118, the voltage-command creation unit 1, the PWM pulse generation unit 13, the alarm processing unit 120, and the current-detection-circuit abnormality diagnosis unit 130 can be accommodated in a control circuit 110b by using a semiconductor integrated circuit, such as a microcomputer or a DSP.

The current-detection-circuit abnormality diagnosis unit 130 determines whether an abnormality is present in the direct-current detection circuit 106, the motor-current detection circuit 107, and the motor-current detection unit 118 on the basis of the direct-current detection signal 121 which is generated by the direct-current detection circuit 106, the PWM signals 20 which are generated by the PWM pulse generation unit 13, and the motor-current detection values 25 generated by the motor-current detection unit 118. The current-detection-circuit abnormality diagnosis unit 130 also generates a current-detection-circuit abnormality signal 131 on the basis of a determination result and transmits the signal to the alarm processing unit 120.

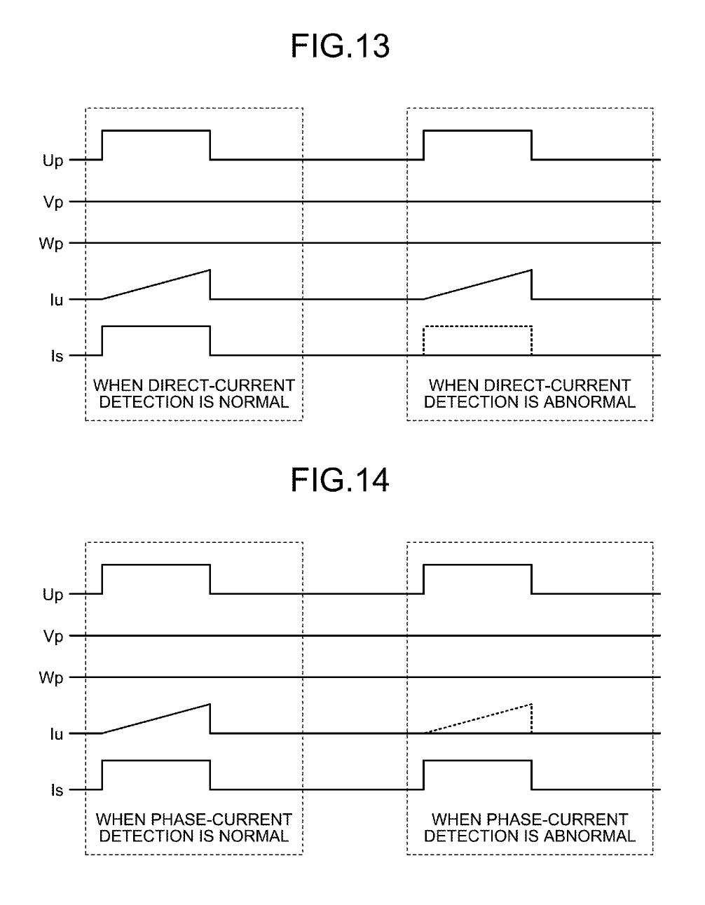

An abnormality detection method used by the current-detection-circuit abnormality diagnosis unit 130 is described with reference to FIGS. 13 and 14. A first example illustrated in FIG. 13 is an example in which the direct-current detection signal 121 (Is) does not become active although the motor-current detection value 25 (Iu: U-phase current value) is detected in a switching pattern that causes the U-phase current to flow. In this case, the current-detection-circuit abnormality diagnosis unit 130 determines that the direct-current detection circuit 106 is abnormal. Similarly, a second example illustrated in FIG. 14 is an example in which the motor-current detection value 25 (Iu: U-phase current value) cannot be detected although the direct-current detection signal 121 (Is) is active in a switching pattern that causes the U-phase current to flow. In this case, the current-detection-circuit abnormality diagnosis unit 130 determines that the motor-current detection circuit 107 or the motor-current detection unit 118 is abnormal. The current-detection-circuit abnormality diagnosis unit 130 transmits an abnormality diagnosis result to the alarm processing unit 120 by way of the current-detection-circuit abnormality signal 131. As a transmission method, the pulse width modulation described in the second embodiment can be used. When notified that an abnormality is detected in one of the current-detection circuits by way of the current-detection-circuit abnormality signal 131, the alarm processing unit 120 performs the processing to stop the motor 4 and notifies the outside of the occurrence of the abnormality so as to ensure safety.

A system that is configured by using a power conversion apparatus and a load commonly uses a current sensor to perform current control for controlling the load. By combining the current sensor and a disconnection detection method using the disconnection detection unit according to the present invention, abnormality detection of the current sensor and the disconnection detection unit is also enabled.

As described above, the motor drive apparatus 111b according to the present embodiment detects an abnormality by using a circuit similar to that used in the motor drive apparatus 111 according to the first embodiment and also detects the occurrence of an abnormality of one of the current-detection circuits by using the current-detection-circuit abnormality diagnosis unit 130. The present embodiment can thus produce effects similar to those produced by the motor drive apparatus 111 according to the first embodiment. The present embodiment can also improve reliability of each of the current-detection circuits by enabling the direct-current detection circuit 106 and the motor-current detection circuit 107, which detect current by two different detection schemes, to monitor each other.

### Fourth Embodiment

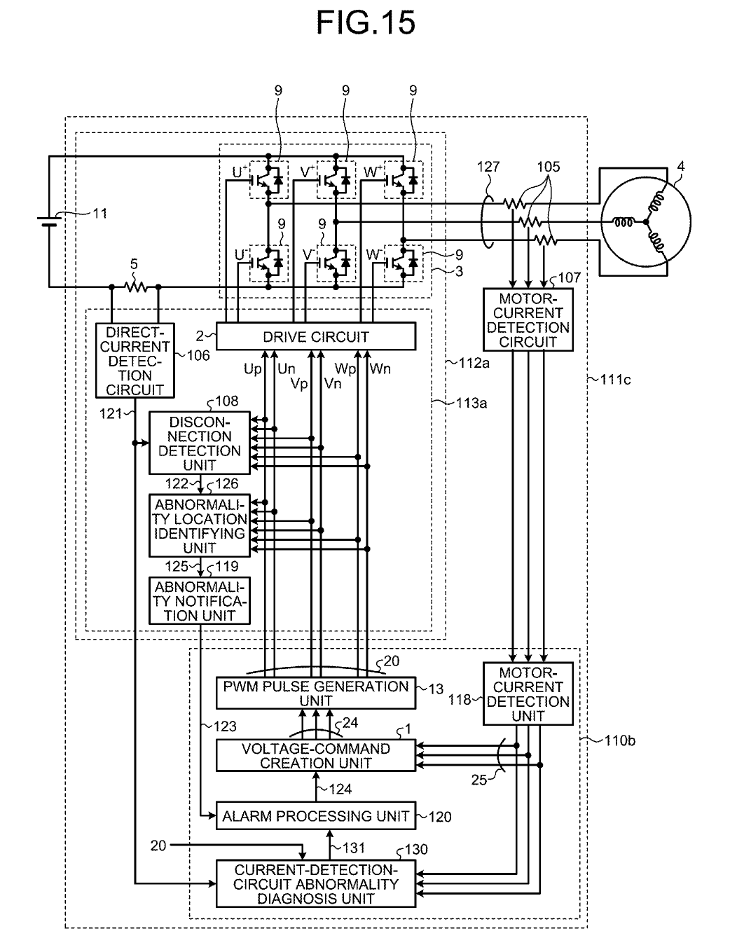

FIG. 15 is a diagram illustrating an exemplary configuration of a power conversion apparatus according to a fourth embodiment of the present invention. The power conversion apparatus illustrated in FIG. 15 is a motor drive apparatus as with the power conversion apparatuses described in the first to third embodiments (see FIGS. 1, 9, and 12). In FIG. 15, constituent elements common with the motor drive apparatuses 111, 111a, and 111b described in the first to third embodiments are designated with identical symbols. Description of the constituent elements common with the motor drive apparatuses 111, 111a, and 111b described in the first to third embodiments is omitted in the present embodiment.

A motor drive apparatus 111c according to the fourth embodiment has a configuration that is similar to that of the motor drive apparatus 111a according to the second embodiment but further includes the current-detection-circuit abnormality diagnosis unit 130, which is included in the motor drive apparatus 111b according to the third embodiment. In other words, the motor drive apparatus 111c is similar to the motor drive apparatus 111a according to the second embodiment but the control circuit 110 in the second embodiment is replaced with the control circuit 110b. The abnormality-location identifying unit 126 and the current-detection-circuit abnormality diagnosis unit 130 in the motor drive apparatus 111c are the same with the abnormality-location identifying unit 126 in the motor drive apparatus 111a according to the second embodiment and the current-detection-circuit abnormality diagnosis unit 130 in the motor drive apparatus 111b according to the third embodiment, respectively, and their detailed description is omitted.

As described above, the motor drive apparatus 111c according to the present embodiment detects an abnormality by using a circuit similar to that used in the motor drive apparatus 111 according to the first embodiment and, if an abnormality is detected, also identifies the abnormality location by using the abnormality-location identifying unit 126 as in the motor drive apparatus 111a according to the second embodiment. Additionally, the motor drive apparatus 111c according to the present embodiment detects the occurrence of an abnormality of one of the current-detection circuits by using the current-detection-circuit abnormality diagnosis unit 130 as in the motor drive apparatus 111b according to the third embodiment. The present embodiment can thus produce effects similar to those produced by the motor drive apparatuses 111, 111a, and 111b according to the first to third embodiments.

The configurations in the embodiments described above represent some examples of the present invention, and they can be combined with another publicly known technique and partially omitted or modified without departing from the spirit of the present invention.

### REFERENCE SIGNS LIST

1 voltage-command creation unit; 2 drive circuit; 3 inverter circuit; 4 motor; 5, 105 shunt resistor; 9 switching element; 11 DC voltage source; 13 PWM pulse generation unit; 106 direct-current detection circuit; 107 motor-current detection circuit; 108 disconnection detection unit; 110, 110b control circuit; 111, 111a, 111b, 111c motor drive apparatus; 112, 112a IPM; 113, 113a multi-function drive circuit; 118 motor-current detection unit; 119 abnormality notification unit; 120 alarm processing unit; 126 abnormality-location identifying unit; 130 current-detection-circuit abnormality diagnosis unit; 501 three-phase-to-two-phase converter; 502 current controller; 503 decoupling controller; 504 two-phase-to-three-phase converter.

1. A power conversion apparatus, comprising:
a power conversion circuit to convert DC power to AC power and supply resultant power to a load;
a control circuit to control a plurality of switching elements that configures the power conversion circuit;
a direct-current detection circuit to detect a direct current flowing into and out from the power conversion circuit; and
an abnormality detection circuit that includes a logic circuit, to detect an abnormality of one of the switching elements or a disconnection of one of power lines connecting the power conversion circuit to the load on a basis of control signals output by the control circuit to the switching elements and a detection result obtained by the direct-current detection circuit.

2. The power conversion apparatus according to claim 1, wherein:
the direct-current detection circuit outputs, to the abnormality detection circuit, a direct-current detection signal indicating whether the direct current is in a flowing state, and
the abnormality detection circuit detects an abnormality of one of the switching elements or a disconnection of one of power lines on a basis of the direct-current detection signal and the control signals.

3. The power conversion apparatus according to claim 1, further comprising:
an abnormality-location identifying circuit to identify one of the switching elements that has an abnormality or one of the power lines that has a disconnection on a basis of a detection result obtained by the abnormality detection circuit and the control signals.

4. The power conversion apparatus according to claim 3, wherein:
the abnormality-location identifying circuit includes a logic circuit and identifies one of the switching elements that has an abnormality or one of the power lines that has a disconnection by comparing the detection result obtained by the abnormality detection circuit to combinations each of which includes states of the switching elements indicated by the control signals.

5. The power conversion apparatus according to claim 3, further comprising:
an abnormality notification circuit to receive an identification result obtained by the abnormality-location identifying circuit and transmit the identification result to the control circuit by using a signal having a pulse width that corresponds to the received identification result.

6. The power conversion apparatus according to claim 1, wherein:
the control circuit detects an abnormality of the direct-current detection circuit and an abnormality of a current detection circuit that detects a current flowing through the power line on a basis of a detection result obtained by the direct-current detection circuit, the control signals, and a detection result obtained by the current detection circuit.

7. The power conversion apparatus according to claim 6, wherein:
the control circuit detects an abnormality of the current-detection circuit on a basis of a detection result obtained by the direct-current detection circuit and the control signals, and detects an abnormality of the direct-current detection circuit on a basis of a detection result obtained by the current-detection circuit and the control signals.

8. The power conversion apparatus according to claim 6 or 7, wherein:
when the control circuit detects an abnormality of the direct-current detection circuit and when the control circuit detects an abnormality of the current-detection circuit, the control circuit stops an operation of the power conversion circuit.

9. The power conversion apparatus according to claim 1, wherein:
when the abnormality detection circuit detects an abnormality of one of the switching elements and when the abnormality detection circuit detects a disconnection of one of the power lines, the control circuit stops an operation of the power conversion circuit.

10. The power conversion apparatus according to claim 1, wherein:
the abnormality detection circuit detects an abnormality of one of the switching elements and a disconnection of one of the power lines when one of combinations each of which includes states of the switching elements corresponds to a specific pattern.

11. The power conversion apparatus according to claim 1, wherein:
the power conversion circuit, the direct-current detection circuit, the abnormality detection circuit, and the control circuit are accommodated in an intelligent power module or a gate-actuating integrated circuit.

12. A logic circuit to detect an abnormality of one of switching elements that configure a power conversion circuit that converts DC power to AC power and supplies the AC power to a load or a disconnection of one of power lines connected to an AC side of the power conversion circuit on a basis of control signals for controlling the switching elements and a direct current flowing into and out from the power conversion circuit.
